(19) United States
(12) Patent Application Publication
(10) Pub. No.: US 2019/0050905 A1
(43) Pub. Date: Feb. 14, 2019

(54) INFORMATION PROVIDING DEVICE, INFORMATION PROVIDING METHOD, AND RECORDING MEDIUM

(71) Applicants: TOYOTA JIDOSHA KABUSHIKI KAISHA, Toyota-shi (JP); TOYOTA Connected Corporation, Nagoya-shi (JP)

(72) Inventors: Masakazu NOMURA, Nagoya-shi (JP); Masato ENDO, Nagakute-shi (JP); Naoki YAMAMURO, Nagoya-shi (JP)

(73) Assignees: TOYOTA JIDOSHA KABUSHIKI KAISHA, Toyota-shi (JP); TOYOTA Connected Corporation, Nagoya-shi (JP)

(21) Appl. No.: 16/057,159

(22) Filed: Aug. 7, 2018

(30) Foreign Application Priority Data
Aug. 10, 2017 (JP) 2017-155828

(51) Int. Cl. G06Q 30/02; H04W 4/024; H04W 4/21; G06K 9/00; G01C 21/36; G06F 17/30

(52) U.S. Cl. CPC G06Q 30/0265; H04W 4/024; H04W 4/21; G06K 2209/21; G01C 21/3641; G06F 17/30864; G06K 2209/23; G06K 9/00825

(57) ABSTRACT

An information providing device includes: a target vehicle detecting unit configured to detect a vehicle which is located near an information display object displaying information; and an information providing unit configured to provide information related to the information displayed on the information display object to at least one of a user in the vehicle and a user who is likely to be in the vehicle when the vehicle detected by the target vehicle detecting unit has passed near the information display object.

### INCORPORATION BY REFERENCE

The disclosure of Japanese Patent Application No. 2017-155828 filed on Aug. 10, 2017 including the specification, drawings and abstract is incorporated herein by reference in its entirety.

### BACKGROUND

### 1. Technical Field

The disclosure relates to an information providing device, an information providing method, and a recording medium.

### 2. Description of Related Art

An information display object that is disposed at a position visible to an occupant in a vehicle on a road, for example, beside or above a road, and presenting information to an occupant in a vehicle is known.

For example, US Patent Application Publication No. 2016/0180709 (US 2016/0180709 A) discloses a digital signage for occupants in a vehicle including a driver in the vehicle as an information display object (see US 2016/0180709 A). Examples of the information display object include a general signboard indicating advertisement information, area information, or the like, a character doll or an object for advertisement, and a road sign in addition to a digital signage.

### SUMMARY

However, even when information displayed on an information display object interests an occupant of a vehicle, there is a likelihood that the occupant will not be able to satisfactorily understand the information. For example, there is a likelihood that a driver will not observe an information display object and will miss an information display object or will not understand all information displayed on an information display object even when the information display object is noticed. Since a moving speed of a vehicle is inherently relatively high, there is a likelihood that an occupant other than a driver will not be able to understand all information displayed on an information display object depending on a time at which the occupant notices the information display object.

The present disclosure provides an information providing device and the like that can facilitate an occupant of a vehicle understanding information displayed on an information display object such as a digital signage which can be seen from a vehicle on a road.

An information providing device according to a first aspect of the present disclosure includes: a target vehicle detecting unit configured to detect a vehicle which is located near an information display object displaying information; and an information providing unit configured to provide related information which is related to the information displayed on the information display object to at least one of a user in the vehicle and a user who is likely to be in the vehicle when the vehicle detected by the target vehicle detecting unit has passed near the information display object.

An information providing method which is performed by an information providing device according to a second aspect of the present disclosure, the information providing method includes: causing the information providing device to detect a vehicle which is located near an information display object displaying information; and causing the information providing device to provide related information which is related to the information displayed on the information display object to at least one of a user in the vehicle and a user who is likely to be in the vehicle when the vehicle detected in the detecting of a vehicle has passed near the information display object.

A computer-readable non-transitory recording medium on which a program is recorded according to a third aspect of the present disclosure, the program including: an operation of detecting a vehicle which is located near an information display object displaying information; and an operation of providing related information which is related to the information displayed on the information display object to at least one of a user in the vehicle and a user who is likely to be in the vehicle when the vehicle detected in the detecting of a vehicle has passed near the information display object.

According to this embodiment, when a vehicle detected near a predetermined information display object which is installed beside a road, just above the road, or the like passes near the information display object, information related to the information display object is provided to a user in the vehicle or a user who is likely to be in the vehicle. For example, by delivering the related information to the vehicle or a mobile terminal of a user of a vehicle which has been registered in advance, that is, a user who is likely to be in the vehicle, the related information can be provided to the user via an onboard device or a display of a mobile terminal. Accordingly, even when an occupant in a vehicle misses an information display object or cannot satisfactorily understand information displayed on the information display object, information related to the information display object is provided and thus it is possible to facilitate the occupant understanding the information displayed on the information display object.

The information providing device may further include: a determination unit configured to determine whether there is a likelihood that an occupant of the vehicle detected by the target vehicle detecting unit is not able to understand the information displayed on the information display object. The information providing unit may be configured to provide the related information to the user when the vehicle detected by the target vehicle detecting unit has passed near the information display object and when the determination unit has determined that there is the likelihood.

According to this embodiment, since the related information is provided to the user in the vehicle or the like only when it is determined that there is a likelihood that an occupant of the vehicle will not be able to understand the information displayed on the information display object, it is possible to prevent the related information from being provided to a user to which the related information does not need to be provided. Accordingly, it is possible to reduce inconvenience to a user who does not need the related information.

In the above aspect, the determination unit may be configured to determine that there is the likelihood when at least one of Condition (i), Condition (ii), and Condition (iii) is satisfied: (i) a vehicle speed of the vehicle is equal to or higher than a predetermined speed; (ii) the information display object is in a backlight state when the occupant looks toward the information display object and (iii) surroundings of the information display object have predetermined bad weather.

According to this embodiment, it is possible to specifically determine whether there is a likelihood that an occupant of a vehicle will not be able to understand the information displayed on the information display object based on the vehicle speed of the vehicle, the positional relationship between the vehicle and the information display object, the weather near the information display object, and the like.

In the above aspect, the information providing unit may be configured to provide the related information to the user by delivering the related information to the vehicle or a mobile phone of the user.

According to this embodiment, an occupant can review the related information delivered to the vehicle or the mobile terminal in real time in response to passing of the vehicle in front of the information display object. Accordingly, for example, in a case of an advertisement for guidance to a nearby store, it is possible to easily guide an occupant of a vehicle to a guidance destination and to enhance advantages of the guidance advertisement or the like.

In the above aspect, the information providing unit may be configured to provide the related information to the user by delivering the related information to an account corresponding to the user in an online service through which the user is able to receive and read information.

According to this embodiment, an occupant of a vehicle can review the information related to the information display object which is delivered to the occupant's account in a mailing service, a social network service (SNS) service, or the like which is used by the occupant later in a situation in which there is time to spare. Accordingly, for example, when the information display object is a web guidance advertisement and there is no time to spare because a user is moving to a destination when the user is in a vehicle, the user can access the web in a situation in which there is time to spare and thus it is possible to enhance advantages of the information display object (advertisement).

In the above aspect, a priority may be defined for the related information in advance. A priority of related information which the information providing unit delivers to the vehicle or a mobile terminal of the user may be higher than a priority of related information which the information providing unit delivers to an account corresponding to the user in an online service. The user may be able to receive and read information through the online service.

According to this embodiment, it is possible to cause an occupant of a vehicle to understand the related information with a relatively high priority in real time by delivery to the vehicle or the mobile terminal and to cause the occupant to check the related information with a relatively low priority later through an online service. Accordingly, when there are a plurality of pieces of related information on one information display object and the plurality of pieces of related information are provided through the same means at one time, an amount of information may be too large and thus there is a likelihood that understanding of the information related to the information display object may not be facilitated. In this case, by appropriately using providing means depending on a priority, it is possible to facilitate a user understanding the related information. For example, by setting related information requiring real time properties (for example, route guidance information for a nearby store) to a relatively high priority and setting related information for which there will be no difficulty in later understanding (for example, URL information of a web page) to a relatively low priority, it is possible to provide information depending on the characteristics of the providing means.

In the above aspect, the related information may include position information of a position of a guidance destination to which the user is guided by the information displayed on the information display object.

According to this embodiment, for example, when an information display object is a guidance advertisement for guidance to a store or the like, position information of a guidance destination is provided to a user and thus it is possible to facilitate guidance of an interested user to the store or the like and to enhance the effects of the guidance advertisement or the like.

In the above aspect, the related information may include route guidance information to guide the user to the guidance destination.

According to this embodiment, since route guidance information to a guidance destination is provided to a user, it is possible to improve convenience to the user who wants to go to the guidance destination, to facilitate guidance of the user to the guidance destination, and to further improve the effects of the guidance advertisement or the like.

In the above aspect, the related information may include supplementary information or detailed information on the information displayed on the information display object.

According to this embodiment, when an amount of information displayed on an information display object is restricted to facilitate an occupant of a vehicle, of which a moving speed is relatively high and thus in which time for noticing the information display object is limited, understanding the information, it is possible to provide the occupant with supplementary information or detailed information for the information displayed on the information display object. Accordingly, it is possible to further facilitate an occupant understanding information displayed on an information display object.

In the above aspect, the related information may include latest information related to the information displayed on the information display object at a time when the information providing unit provides the related information.

According to this embodiment, even in a case of an information display object such as a standing signboard for which frequent updating is difficult, it is possible to provide the latest information associated with the information displayed on the information display object, for example, sale information of a store as a guidance destination of a guidance advertisement, to an occupant of a vehicle.

The information providing device may further include a related information storing unit configured to store the related information in correlation with the information display object.

The information providing device may further include an input receiving unit configured to receive the related information which is input. The related information storing unit may be configured to store the related information received by the input receiving unit in correlation with the information display object.

According to this embodiment, since the related information stored in correlation with the information display object can be additionally input, for example, by a manager or an advertiser, it is possible to enrich the related information and to improve the effects of the information display object (an advertisement).

The information providing device may further include an information collecting unit configured to collect the related information based on online information including at least one of web information and SNS information. The related information storing unit may be configured to store the related information collected by the information collecting unit in correlation with the information display object.

According to this embodiment, since information related to an information display object is collected based on online information and is stored in correlation with the information display object, it is possible to enrich the related information and to improve the effects of the information display object (an advertisement).

The information providing device may further include an information display object storing unit configured to store a data corresponding to the information display object and position information of the information display object in correlation with the data.

The information providing device may further include: an image receiving unit configured to receive a captured image which is captured by an imaging unit that images the surroundings of a vehicle from the vehicle including the imaging unit; and an extraction unit configured to extract an image of the information display object as the data from the captured image.

According to this embodiment, since an information display object is extracted from a captured image of the imaging unit of a probe vehicle and is stored in correlation with position information thereof and related information, it is possible to enhance the number of information display objects for which related information is delivered. Accordingly, it is possible to improve convenience to an occupant of a vehicle.

The information providing device may further include a search unit configured to search for the data and the position information based on online information including web information or SNS information.

According to this embodiment, since an information display object and position information thereof are searched for based on online information and the found information display object, the position information thereof, and information related thereto are stored in correlation with each other, it is possible to increase the number of information display objects for which related information is delivered. Accordingly, it is possible to improve convenience to an occupant of a vehicle.

According to the above-mentioned embodiments, it is possible to provide an information providing device and the like that can facilitate an occupant of a vehicle understanding information displayed on an information display object such as a digital signage which can be seen from a vehicle on a road.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram schematically illustrating an example of a configuration of an information delivery system;

FIG. 2 is a functional block diagram illustrating an example of a functional configuration of a vehicle (an ECU);

FIG. 3 is a functional block diagram illustrating an example of a functional configuration of a mobile terminal (a processor);

FIG. 4 is a functional block diagram illustrating an example of a functional configuration of a central server (a processor) according to a first embodiment;

FIG. 5 is a flowchart schematically illustrating an example of a processing routine which is performed by the central server (the processor) according to the first embodiment;

FIG. 6A is a diagram illustrating a specific operation of the information delivery system;

FIG. 6B is a diagram illustrating a specific operation of the information delivery system;

FIG. 6C is a diagram illustrating a specific operation of the information delivery system;

FIG. 7 is a diagram illustrating an example of a functional configuration of a central server (a processor) according to a second embodiment;

FIG. 8 is a flowchart schematically illustrating an example of a processing routine which is performed by the central server (the processor) according to the second embodiment; and

FIG. 9 is a flowchart schematically illustrating an example of a processing routine which is performed by a central server (a processor) according to a third embodiment.

### DETAILED DESCRIPTION OF EMBODIMENTS

Hereinafter, embodiments of the disclosure will be described with reference to the accompanying drawings.

### First Embodiment

[Configuration of Information Delivery System]

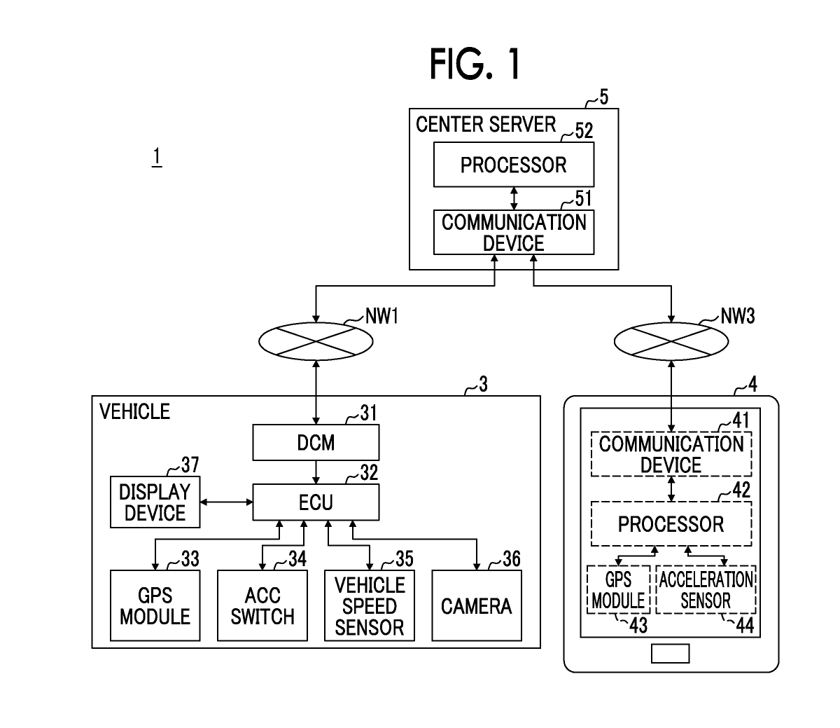

First, a configuration of an information delivery system 1 according to a first embodiment will be described below with reference to FIGS. 1 to 4.

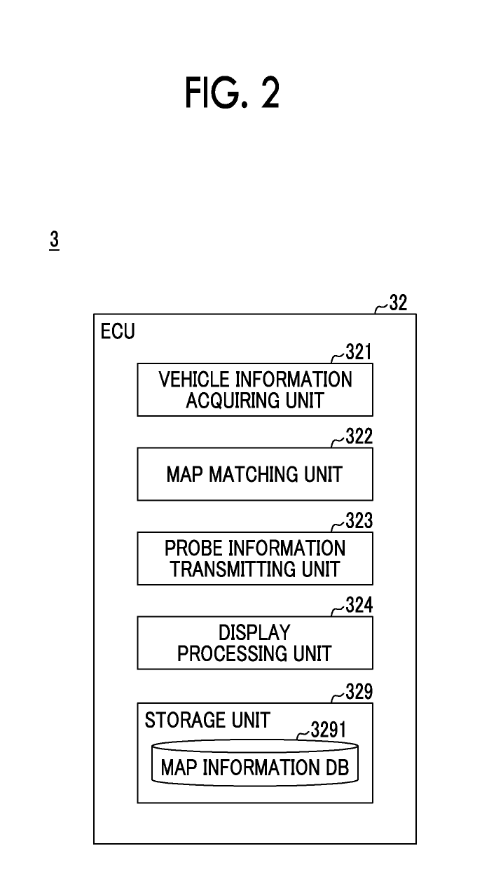

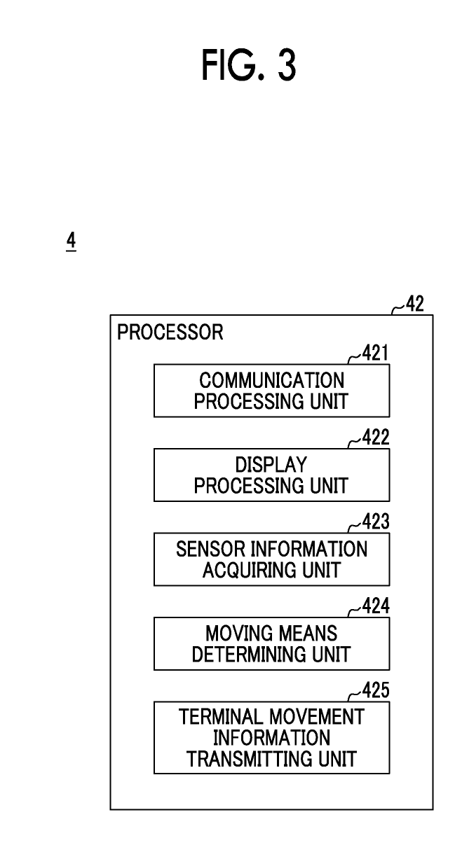

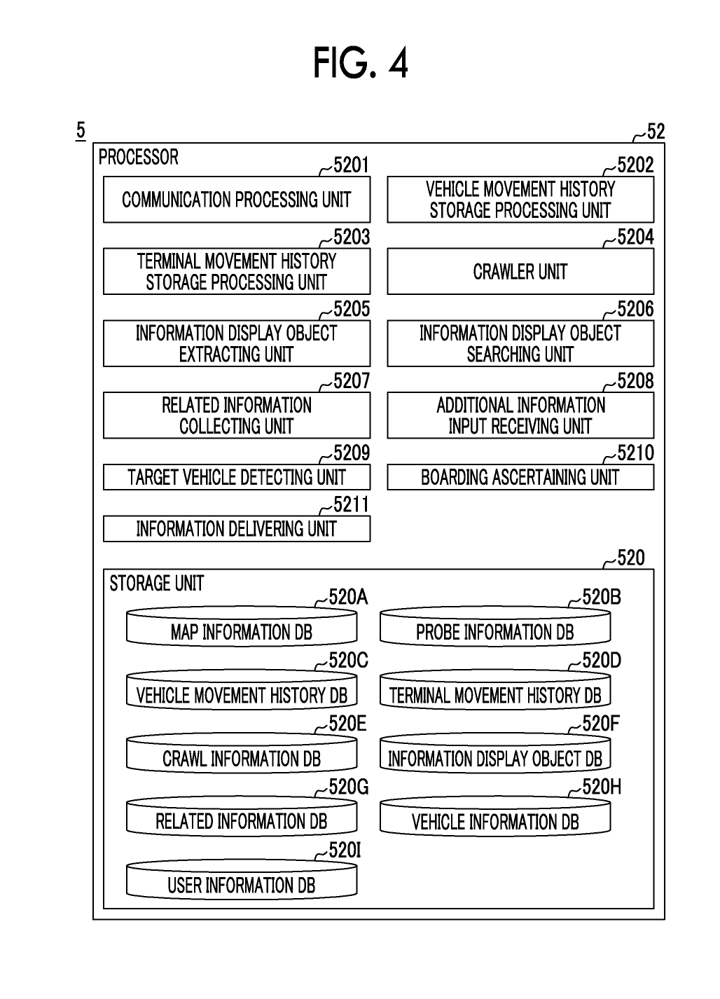

FIG. 1 is a diagram schematically illustrating a configuration of the information delivery system 1. FIG. 2 is a functional block diagram schematically illustrating an example of a functional configuration of a vehicle 3 (an ECU 32). FIG. 3 is a functional block diagram schematically illustrating an example of a functional configuration of a mobile terminal 4 (a processor 42). FIG. 4 is a functional block diagram schematically illustrating an example of a configuration of a central server 5 (a processor 52).

The information delivery system 1 includes a plurality of vehicles 3, a plurality of mobile terminals 4, and a central server 5 that is communicatively connected to the plurality of vehicles 3 and the plurality of mobile terminals 4. The information delivery system 1 delivers information related to an information display object (for example, a digital signage, a normal signboard, or a road sign) that is installed beside a road or above a road to a vehicle 3 passing in front of or below the information display object, that is, a vehicle 3 or the like passing through a road section at which the information display object can be seen.

Since configurations of the plurality of vehicles 3 associated with the information delivery system 1 are substantially the same, one vehicle 3 is representatively illustrated in the drawings. Since configurations of the plurality of mobile terminals 4 associated with the information delivery system 1 are substantially the same, one mobile terminal 4 is representatively illustrated in the drawings.

The vehicle 3 includes a data communication module (DCM) 31, an electronic control unit (ECU) 32, a global positioning system (GPS) module 33, an ACC switch 34, a vehicle speed sensor 35, a camera 36, and a display device 37.

The DCM 31 is a communication device that bidirectionally communicates with the central server 5 via a predetermined communication network NW1 (for example, a mobile phone network with a plurality of base stations as terminals or an Internet network (which is true of a communication network NW2)). The DCM 31 is communicatively connected to various ECUs including the ECU 32 via an onboard network such as a controller area network (CAN).

The ECU 32 is an electronic control unit that performs various control processes associated with predetermined functions in the vehicle 3. For example, the ECU 32 has a function of acquiring information (vehicle information) on a state of the vehicle 3 and a state of the surroundings of the vehicle 3 and uploading the acquired vehicle information as probe information to the central server 5 via the DCM 31. For example, the information on the state of the vehicle 3 includes detection information of various sensors such as the GPS module 33, the ACC switch 34, the vehicle speed sensor 35. For example, the information of the state of the surroundings of the vehicle 3 includes an image of the surroundings of the vehicle 3 which is captured by the camera 36.

The functions of the ECU 32 may be embodied by arbitrary hardware, arbitrary software, or a combination thereof, and the ECU 32 may be constituted mainly, for example, by a microcomputer including a central processing unit (CPU), a random access memory (RAM), a read only memory (ROM), an auxiliary storage device, and an input-output interface (I/O). The ECU 32 includes a vehicle information acquiring unit 321, a map matching unit 322, a probe information transmitting unit 323, and a display processing unit 324 as functional units which are embodied, for example, by causing the CPU to execute one or more programs stored in the ROM or the auxiliary storage device. For example, the ECU 32 includes a storage unit 329 which is a storage area defined in the auxiliary storage device. The storage unit 329 includes a map information database (DB) 3291 including geographic information system (GIS) data including nodes corresponding to crossings, road links connecting the nodes, and lines or polygons corresponding to planimetric features such as buildings or roads.

Some functions of the ECU 32 may be assigned to one or more other ECUs.

The vehicle information acquiring unit 321 acquires vehicle information input from the GPS module 33, the ACC switch 34, the vehicle speed sensor 35, and the camera 36 from a buffer in the RAM. Specifically, the vehicle information acquiring unit 321 acquires position information of the vehicle 3 which is input from the GPS module 33. The vehicle information acquiring unit 321 acquires a signal associated with an ON/OFF state (an ON signal or an OFF signal) of the ACC switch 34 which is input from the ACC switch 34. The vehicle information acquiring unit 321 acquires information on a vehicle speed (vehicle speed information) of the vehicle 3 which is input from the vehicle speed sensor 35. The vehicle information acquiring unit 321 acquires a captured image input from the camera 36.

The map matching unit 322 identifies a road link corresponding to the position information of the vehicle 3, that is, a road link on which the vehicle 3 is currently located, based on the map information DB 3291 stored in the storage unit 329 and the position information of the vehicle 3 which is acquired by the vehicle information acquiring unit 321. For example, identification information, that is, link identifier (ID), may be defined for a plurality of road links constituting a road network included in the map information DB 3291 in advance. The map matching unit 322 identifies a link ID of the road link on which the vehicle 3 is currently located.

Instead, the function of the map matching unit 322 may be provided in the central server 5. In this case, the central server 5 can identify a link ID of the road link on which the vehicle 3 is currently located based on the position information included in probe information, which will be described later, transmitted from each vehicle 3.

The probe information transmitting unit 323 generates probe information including a variety of vehicle information acquired by the vehicle information acquiring unit 321, time information corresponding to the variety of vehicle information, and road links identified by the map matching unit 322 in each of time periods. Then, the probe information transmitting unit 323 transmits the generated probe information to the central server 5 via the DCM 31.

The probe information which is transmitted from the vehicle 3 to the central server 5 may not include time information corresponding to the variety of vehicle information. In this case, the central server 5 can add a time at which vehicle movement information has been transmitted from the vehicle 3, a time at which the vehicle movement information has been received by the central server 5, a time at which the vehicle 3 is located at an actual position corresponding to the position information and which is calculated from the times, or the like as the time information corresponding to the variety of vehicle information to the probe information received from the vehicle 3.

The display processing unit 324 performs a process of displaying a predetermined information screen on the display device 37 in response to an operation which is performed by an occupant such as a driver of the vehicle 3. For example, the display processing unit 324 may perform a process of displaying a variety of information transmitted from the central server 5 to the vehicle 3 on the display device 37.

The GPS module 33 receives GPS signals which are transmitted from three or more satellites, preferably, four or more satellites, above the vehicle 3 and measures the position of the vehicle 3 in which the GPS module 33 is mounted. The GPS module 33 is communicatively connected to the ECU 32 via a one-to-one communication line or an onboard network such as a CAN, and the measured position information of the vehicle 3 is input to the ECU 32.

The ACC switch 34 switches an accessory power source of the vehicle 3 to ON/OFF states in response to a predetermined operation which is performed by an occupant such as a driver of the vehicle 3. For example, the ACC switch 34 may be switched to the ON/OFF states in response to an operation of a power switch, that is, a button type switch for operating the ACC switch 34 and an ignition switch (an IG switch), which is provided in an instrument panel near a steering wheel of a driver seat in the vehicle. An output signal of the ACC switch 34 is an example of information indicating starting and stopping of the vehicle 3. Specifically, when the output signal of the ACC switch 34 is switched from an OFF signal to an ON signal, it refers to starting of the vehicle 3. When the output signal of the ACC switch 34 is switched from the ON signal to the OFF signal, it refers to stopping of the vehicle 3. The ACC switch 34 is communicatively connected to the ECU 32 or the like via a one-to-one communication line or an onboard network such as a CAN, and a state signal thereof (an ON signal/OFF signal) is input to the ECU 32.

The information indicating starting and stopping of the vehicle 3 may be an output signal of the IG switch of the vehicle 3.

The vehicle speed sensor 35 is an existing detector that detects a vehicle speed of the vehicle 3. The vehicle speed sensor 35 is communicatively connected to the ECU 32 via a one-to-one communication line or an onboard network such as a CAN, and the vehicle speed information of the vehicle 3 is input to the ECU 32.

The camera 36 is an imaging unit that is attached to a central upper part on the inside of a front windshield of the vehicle 3 and images a predetermined imaging range in front of the vehicle 3. The camera 36 is started by ignition-ON (IG-ON) of the vehicle 3, and images a predetermined imaging range in front of the vehicle 3 in each of time periods, for example, at intervals of 1/30 seconds from the start to ignition-OFF (IG-OFF) of the vehicle 3. The camera 36 is communicatively connected to the ECU 32 via a one-to-one communication line or an onboard network such as a CAN, and the captured image is input to the ECU 32.

The display device 37 is disposed at a position which can be easily seen by an occupant such as a driver of the vehicle 3, for example, in a central upper part of the instrument panel of the inside of the vehicle, and displays various information screens or various operation screens under the control of the ECU 32 (specifically, the display processing unit 324). The display device 37 is, for example, a touch panel type liquid crystal display.

Examples of the mobile terminal 4 include a mobile phone, a smartphone, and a tablet terminal which is carried by a user of the vehicle 3. The mobile terminal 4 includes a communication device 41, a processor 42, a GPS module 43, an acceleration sensor 44, and a touch panel display (hereinafter simply referred to as a “display”) 45.

The communication device 41 is a device that bidirectionally communicates with the central server 5 via a predetermined communication network NW2 under the control of the processor 42. For example, the communication device 41 is a mobile communication module corresponding to a predetermined communication standard such as long term evolution (LTE), 4G (4th Generation), or 5G (5th Generation).

The processor 42 performs various control processes in the mobile terminal 4. The processor 42 is mainly constituted, for example, by a computer including a CPU, a RAM, a ROM, an auxiliary storage device, and an I/O. The processor 42 includes a communication processing unit 421, a display processing unit 422, a sensor information acquiring unit 423, a moving means determining unit 424, and a terminal movement information transmitting unit 425 as functional units which are embodied, for example, by causing the CPU to execute one or more programs stored in the ROM or the auxiliary storage device.

The communication processing unit 421 controls the communication device 41 such that it transmits and receives various signals to and from the central server 5.

The display processing unit 422 displays various images on the display 45. For example, the display processing unit 422 displays various graphical user interfaces (GUIs) as an operation screen on the display 45. For example, the display processing unit 422 displays a variety of information transmitted from the central server 5 on the display 45.

The sensor information acquiring unit 423 acquires sensor information which is input from various sensors such as the GPS module 43 from a buffer in the RAM. Specifically, the sensor information acquiring unit 423 acquires position information of the mobile terminal 4 which is input from the GPS module 43. The sensor information acquiring unit 423 acquires information on an acceleration (acceleration information) of the mobile terminal 4 which is input from the acceleration sensor 44.

The moving means determining unit 424 determines whether a user carrying the mobile terminal 4 is moving in a vehicle (hereinafter simply referred to as a “vehicle as moving means”) other than public transportation (a bus) as moving means or by other moving means (on foot, on a bicycle, on a train, in a bus, or the like) using an arbitrary method. For example, the moving means determining unit 424 may perform the determination, for example, by employing a discriminator that has been subjected to machine learning in advance to distinguish between a case in which the user is moving in a vehicle as moving means and a case in which the user is moving by moving means other than a vehicle based on the acceleration information which is input from the acceleration sensor 44. For example, the moving means determining unit 424 may determine whether the user is moving in a vehicle as moving means or by moving means other than a vehicle based on the position information of the mobile terminal 4 which is input from the GPS module 43 in addition or instead of the acceleration information which is input from the acceleration sensor 44.

The public transportation in this embodiment does not include a taxi. That is, a vehicle other than the public transportation can include a taxi. The moving means determining unit 424 may simply determine whether the user of the mobile terminal 4 is moving in a vehicle including public transportation (a bus) as moving means or is moving by other moving means. Accordingly, for example, the moving means determining unit 424 can determine whether the user carrying the mobile terminal 4 is moving in a vehicle including public transportation as moving means or is moving by other moving means by simply determining a moving speed of the mobile terminal 4 and whether the mobile terminal is moving on rails.

The terminal movement information transmitting unit 425 generates information on movement of the mobile terminal 4 (terminal movement information), that is, movement of a user carrying the mobile terminal 4, and transmits the generated terminal movement information to the central server 5 via the communication processing unit 421. The terminal movement information can include the position information of the mobile terminal 4 and the determination result from the moving means determining unit 424 (for example, whether there is a vehicle movement tag indicating that a vehicle is moving).

The GPS module 43 receives GPS signals which are transmitted from three or more satellites, preferably, four or more satellites, above the mobile terminal 4 and measures the position of the mobile terminal 4 in which the GPS module 43 is mounted. The measured position information of the mobile terminal 4 is input to the processor 42.

The position information of the mobile terminal 4 may be acquired by base station positioning based on exchange of signals between base stations instead of or in addition to the GPS positioning using the GPS module 43.

The acceleration sensor 44 is, for example, an existing detector that detects an acceleration of the mobile terminal 4 using a micro electro mechanical system (MEMS) technique.

The central server 5 (an example of an information providing device) collects probe information from a plurality of vehicles 3 and delivers information which will be described later to the plurality of vehicles 3 and the users of the plurality of mobile terminals 4. The central server 5 includes a communication device 51 and a processor 52.

The communication device 51 is a device that bidirectionally communicates with a plurality of vehicles 3 and a plurality of mobile terminals 4 via predetermined communication networks NW1 and NW2 under the control of the processor 52 (specifically, a communication processing unit 5201).

The processor 52 (an example of a computer) performs various control processes in the central server 5. The processor 52 is mainly constituted, for example, by one or more server computers including a CPU, a RAM, a ROM, an auxiliary storage device, and an I/O. The processor 52 includes a communication processing unit 5201, a vehicle movement history storage processing unit 5202, a terminal movement history storage processing unit 5203, a crawler unit 5204, an information display object extracting unit 5205, an information display object searching unit 5206, a related information collecting unit 5207, an additional information input receiving unit 5208, a target vehicle detecting unit 5209, a boarding ascertaining unit 5210, and an information delivering unit 5211 as functional units which are embodied, for example, by causing the CPU to execute one or more programs stored in the ROM or the auxiliary storage device. The processor 52 also includes a storage unit 520 as a storage area which is defined in an auxiliary storage device or an external storage device connected to a server computer. A map information DB 520A, a probe information DB 520B, a vehicle movement history DB 520C, a terminal movement history DB 520D, a crawl information DB 520E, an information display object DB 520F, a related information DB 520G, a vehicle information DB 520H, and a user information DB 520I are stored in the storage unit 520.

The communication processing unit 5201 controls the communication device 51 such that it transmits and receives various signals (such as a control signal and an information signal) to and from a plurality of vehicles 3 and a plurality of mobile terminals.

The vehicle movement history storage processing unit 5202 performs a process of processing probe information which is sequentially received from a plurality of vehicles 3 by the communication processing unit 5201 and stored in the probe information DB 520B and storing the processed information as movement histories of the vehicles 3 (vehicle movement histories) in the vehicle movement history DB 520C. For example, the vehicle movement history storage processing unit 5202 may generate information on a movement history (trip information) for every period from starting to stopping of each vehicle 3, that is, for each trip, based on time-series data of the probe information of the plurality of vehicles 3 which is stored in the probe information DB 520B. In other words, the vehicle movement history storage processing unit 5202 generates trip information from a departure point to a destination for each trip of the vehicle 3. Specifically, the vehicle movement history storage processing unit 5202 determines starting of the vehicle 3 based on the ON signal of the ACC switch 34 included in the time-series data of the probe information, and defines the position information of the vehicle 3 included in the probe information at the time of starting of the vehicle 3 as a start point (a departure point) of this trip of the vehicle 3. The vehicle movement history storage processing unit 5202 defines the position information of the vehicle 3 which is included in latest probe information including an OFF signal of the ACC switch 34 in the probe information after the probe information was transmitted in a time series as an end point (a destination) of this trip of the vehicle 3. Then, the vehicle movement history storage processing unit 5202 combines two pieces of probe information associated with both the start point and the end point of one trip of the vehicle 3 and a plurality of pieces of probe information (a probe information group) between the two pieces of probe information in a time series and generates trip information. The vehicle movement history storage processing unit 5202 stores the generated trip information of each vehicle 3 in the vehicle movement history DB 520C in correlation with identification information of the corresponding vehicle 3, for example, a vehicle index number (VIN) or a predetermined vehicle identifier (ID).

The process which is performed by the vehicle movement history storage processing unit 5202 may be performed in real time to correspond to the probe information which is sequentially received from a plurality of vehicles 3 by the communication processing unit 5201, or may be periodically performed on non-processed probe information which has been collected to a certain extent.

The terminal movement history storage processing unit 5203 performs a process of storing terminal movement information which is sequentially received from a plurality of mobile terminals 4 by the communication processing unit 5201 as movement histories of the mobile terminals 4 in the terminal movement history DB 520D. Specifically, the terminal movement history storage processing unit 5203 stores the terminal movement information of each mobile terminal 4 in the terminal movement history DB 520D in correlation with identification information of the corresponding mobile terminal 4, for example, a predetermined terminal ID.

The process which is performed by the terminal movement history storage processing unit 5203 may be performed in real time to correspond to the terminal movement information which is sequentially received from a plurality of mobile terminals 4 by the communication processing unit 5201, or may be periodically performed on non-processed terminal movement information which has been collected to a certain extent in a buffer of the RAM or the like.

The crawler unit 5204 periodically collects (downloads) information from web sites over the Internet or SNS based on an existing algorithm and stores the collected information in the crawl information DB 520E.

The information display object extracting unit 5205 (an example of an extraction unit) extracts an information display object (an image of the information display object) from captured images of the camera 36 included in the probe information of a plurality of vehicles 3 which is stored in the probe information DB 520B based on an existing image recognition process. The information display object extracting unit 5205 adds unique identification information to the extracted information display object and stores the identification information in the information display object DB 520F (an example of an information display object storing unit) in correlation with an image of the information display object and meta information such as position information of the information display object. Accordingly, information on the information display object extracted by the information display object extracting unit 5205 is registered in the information display object DB 520F in addition to information on information display objects which are registered in advance such as standing signboards or digital signages on which advertisement information of predetermined advertisers is displayed. Accordingly, since the information display objects to which related information which will be described later is delivered are enriched, it is possible to improve convenience to users.

The position information of the information display object which is added as meta information may be the position information of the vehicle 3 included in the same probe information as a captured image as an extraction source or may be position information in which position information of the information display object relative to the vehicle 3 which is calculated from the captured image is taken into account. When it is determined that the extracted information display object is the same as an information display object registered already in the information display object DB 520F, the information display object extracting unit 5205 does not store the information on the extracted information display object in the information display object DB 520F. The process which is performed by the information display object extracting unit 5205 may be performed in real time to correspond to the probe information which is sequentially received from a plurality of vehicles 3 by the communication processing unit 5201 or may be periodically performed on non-processed probe information which has been collected to a certain extent.

The information display object searching unit 5206 (an example of a search unit) searches for information on an information display object of which the position can be identified from crawl information from the web or an SNS which is stored in the crawl information DB 520E. The information display object searching unit 5206 adds unique identification information to the searched-for information display object as the search result, and stores the identification information in the information display object DB 520F in correlation with an image of the information display object and meta information such as the position information of the information display object.

When it is determined that the extracted information display object is the same as an information display object registered already in the information display object DB 520F, the information display object searching unit 5206 does not store the information on the extracted information display object in the information display object DB 520F. The process which is performed by the information display object searching unit 5206 may be performed in real time to correspond to update of the crawl information DB 520E by the crawler unit 5204 or may be periodically performed on crawl information which has been collected to a certain extent.

A related information collecting unit 5207 (an example of an information collecting unit) collects information related to an information display object registered in the information display object DB 520F from an image of the information display object extracted by the information display object extracting unit 5205 or crawl information of a web or an SNS stored in the crawl information DB 520E. The information related to the information display object includes contents of information which is displayed on the information display object and which is collected based on an image of the information display object or the like. The information related to the information display object includes position information including route guidance information for a place of an establishment associated with information displayed on the information display object, for example, position information of a store, an establishment, or the like to which it is intended to guide users by advertisement information displayed on the information display object. The information related to the information display object includes additional information such as information more specifically representing the information displayed on the information display object, supplementary information for supplementing the information displayed on the information display object, newer latest information (for example, information which can be updated in a time series such as arrival information or sale information of products) associated with advertisement information of a certain store associated with the information displayed on the information display object, and word-of-mouth information associated with the information displayed on the information display object. The related information collecting unit 5207 stores the collected related information and information on registration times in the related information DB 520G (an example of a related information storing unit) in correlation with the identification information of the corresponding information display object. Accordingly, since the information related to the information display object which is transmitted to the vehicle 3 or the mobile terminal 4 of the user can be enriched as will be described later, it is possible to improve convenience to users.

The process which is performed by the related information collecting unit 5207 may be performed in real time to correspond to a process of extracting an information display object in the information display object extracting unit 5205 or a process of updating the crawl information DB 520E in the crawler unit 5204 or may be periodically performed on images of the extracted information display objects or crawl information which has been collected to a certain extent.

The additional information input receiving unit 5208 (an example of an input receiving unit) receives additional information on the information display object registered in the information display object DB 520F which is input via an input device of the processor 52, the Internet, or the like. The additional information input receiving unit 5208 stores the received additional information and the information on the registration time as the information related to the corresponding information display object in the related information DB 520G in correlation with the identification information of the information display object. For example, a manager of the central server 5 or an advertiser of advertisement information displayed on an information display object can input additional information on an information display object which is already registered in the information display object DB 520F via a predetermined input device (not illustrated) connected to the processor 52 or a predetermined web page. Accordingly, since the information related to the information display object which is transmitted to the vehicle 3 or the mobile terminal 4 of the user can be enriched as will be described later, it is possible to improve convenience to users.

The target vehicle detecting unit 5209 detects a vehicle 3 (a target vehicle) which is located near an information display object registered in the information display object DB 520F based on position information included in latest probe information received from a plurality of vehicles 3 by the communication processing unit 5201. Specifically, the target vehicle detecting unit 5209 detects a vehicle 3 which is located on a road near the installation position of the information display object registered in the information display object DB 520F, that is, a road from which the information display object can be seen from a vehicle 3 traveling thereon, such that a vehicle front faces the information display object.

The target vehicle detecting unit 5209 determines whether the vehicle 3 has passed near the corresponding information display object (for example, in front of the information display object installed on a road side or below an information display object installed just above the road) based on the position information of the vehicle 3 as a target vehicle which is sequentially received by the communication processing unit 5201. That is, the target vehicle detecting unit 5209 determines whether the vehicle 3 as a target vehicle has passed by a section in which the information display object can be seen (hereinafter referred to as a “visible section”) on a road near the information display object. In general, since an occupant of a vehicle 3 sees an information display object in front of or beside the vehicle 3, the occupant cannot see the information display object without looking back when the vehicle 3 has passed by the front of an information display object installed on the road side or has passed below an information display object installed on the road.

For example, on the premise that the central server 5 is communicatively connected to an information display object such as a digital signage on which a variety of information is displayed based on delivery of information from the central server, the function of the target vehicle detecting unit 5209 may be installed in the information display object (the digital signage). In this case, the information display object may be configured to detect a target vehicle (a vehicle 3) based on an output of a sensor such as a camera installed in the information display object and to transmit the detection result to the central server 5.

The boarding ascertaining unit 5210 identifies a user in the vehicle 3 (the target vehicle) detected by the target vehicle detecting unit 5209 based on the vehicle information DB 520H. In the vehicle information DB 520H, a mobile terminal 4 of a user of each vehicle 3 is registered in correlation with the corresponding vehicle 3. Accordingly, the boarding ascertaining unit 5210 can ascertain the user of the mobile terminal 4 registered in correlation with the vehicle 3 detected by the target vehicle detecting unit 5209 as a user who is likely to be in the vehicle 3.

The boarding ascertaining unit 5210 determines whether the user who is likely to be in the vehicle 3 as a target vehicle is actually in the vehicle 3. For example, the boarding ascertaining unit 5210 compares the position information included in the latest probe information of the vehicle 3 which is stored in the probe information DB 520B with the position information included in the latest terminal movement information of the mobile terminal 4 of the user who is likely to be in the vehicle 3 which is received by the communication processing unit 5201. Accordingly, the boarding ascertaining unit 5210 can determine whether the user of the mobile terminal 4 is in the vehicle 3 and can identify the user in the vehicle 3 as a result.

Correlation information between the vehicle 3 registered in the vehicle information DB 520H and the mobile terminal 4 may be defined by an online registration process of the user of the vehicle 3 and mobile terminal 4 via a predetermined website.

The correlation information between the vehicle 3 and the mobile terminal 4 stored in the vehicle information DB 520H may be defined, for example, by comparing the movement history of the mobile terminal 4 (the terminal movement history) stored in the terminal movement history DB 520D with the movement history of the vehicle 3 (the vehicle movement history) stored in the vehicle movement history DB 520C. Specifically, when trip information in a vehicle movement history of a vehicle 3 and a part of a terminal movement history of a mobile terminal 4 match each other, it can be determined that a user of the mobile terminal 4 is in the vehicle 3. Accordingly, the vehicle information DB 520H may be constructed by identifying a mobile terminal 4 of a user of each vehicle 3 based on a boarding history (the number of times of boarding) of the vehicle 3.

When the target vehicle detecting unit 5209 has determined that a target vehicle (a vehicle 3) has passed near the corresponding information display object, the information delivering unit 5211 (an example of an information providing unit) delivers the information related to the information display object to the vehicle 3 and the mobile terminal 4 of the user in the vehicle 3 ascertained by the boarding ascertaining unit 5210 via the communication processing unit 5201. Accordingly, an occupant (a user) in the vehicle 3 can check the information related to the information display object which is delivered to the vehicle 3 or the mobile terminal 4 of the occupant via the display device 37 of the vehicle 3 or the display 45 of the mobile terminal 4 in real time. Accordingly, for example, when a user in a vehicle 3 has missed an information display objector has not satisfactorily understood information displayed on the information display object, it is possible to facilitate the user understanding the information displayed on the information display object using the information related to the information display object provided thereto.

The information delivering unit 5211 may deliver the information related to the information display object to a mobile terminal 4 of a user who is likely to be in the target vehicle (the vehicle 3) detected by the target vehicle detecting unit 5209, that is, a mobile terminal 4 registered in correlation with the vehicle 3 in the vehicle information DB 520H. The same is true of a second embodiment and a third embodiment.

When it is determined that the target vehicle (the vehicle 3) detected by the target vehicle detecting unit 5209 has passed near the corresponding information display object, the information delivering unit 5211 deliver the information related to the information display object to an account corresponding to a user in an online service through which the user in the vehicle 3 or the user who is likely to be in the vehicle 3 is able to receive and read information via the communication processing unit 5201. Accordingly, the user in the vehicle 3 can review the information related to the information display object which has delivered to the user's account in an online service such as a mail service or an SNS service which is used by the user later in a situation in which there is time to spare. In the user information DB 5201, for example, information on the account in the online service which is registered in advance by the user of the vehicle 3 or the mobile terminal 4 via a predetermined web page is registered in correlation with at least one of the vehicle 3 and the mobile terminal 4. Accordingly, the information delivering unit 5211 can determine that an account correlated with the vehicle 3 detected by the target vehicle detecting unit 5209 in the user information DB 5201 is an account of the user who is likely to be in the vehicle 3. The information delivering unit 5211 can determine that an account correlated with the mobile terminal 4 of the user who is identified to be in the vehicle 3 by the boarding ascertaining unit 5210 in the user information DB 5201 is the account of the user in the vehicle 3.

[Details of Operation of Information Delivery System]

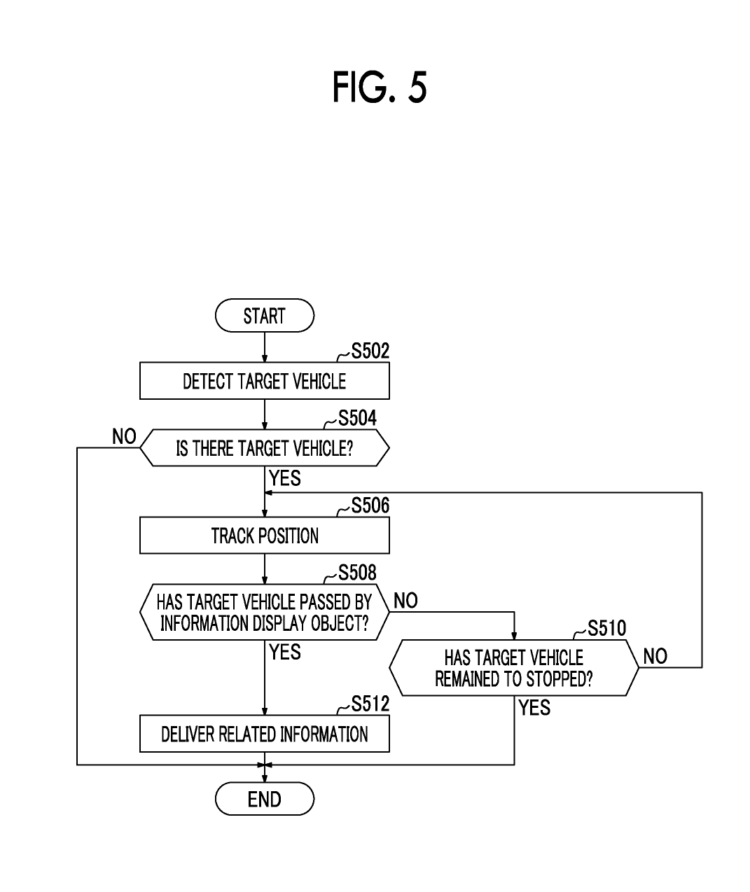

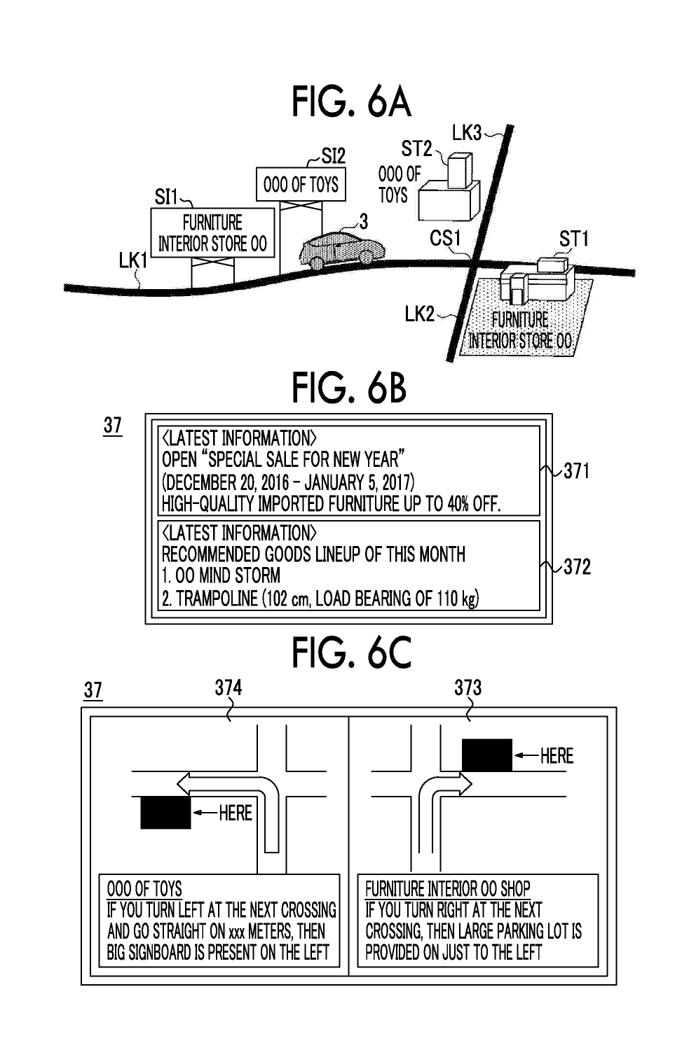

A specific operation of the information delivery system 1 according to this embodiment will be described below with reference to FIGS. 5, 6A, 6B, and 6C.

FIG. 5 is a flowchart schematically illustrating an example of a processing routine which is performed by the processor 52 of the central server 5 according to this embodiment.

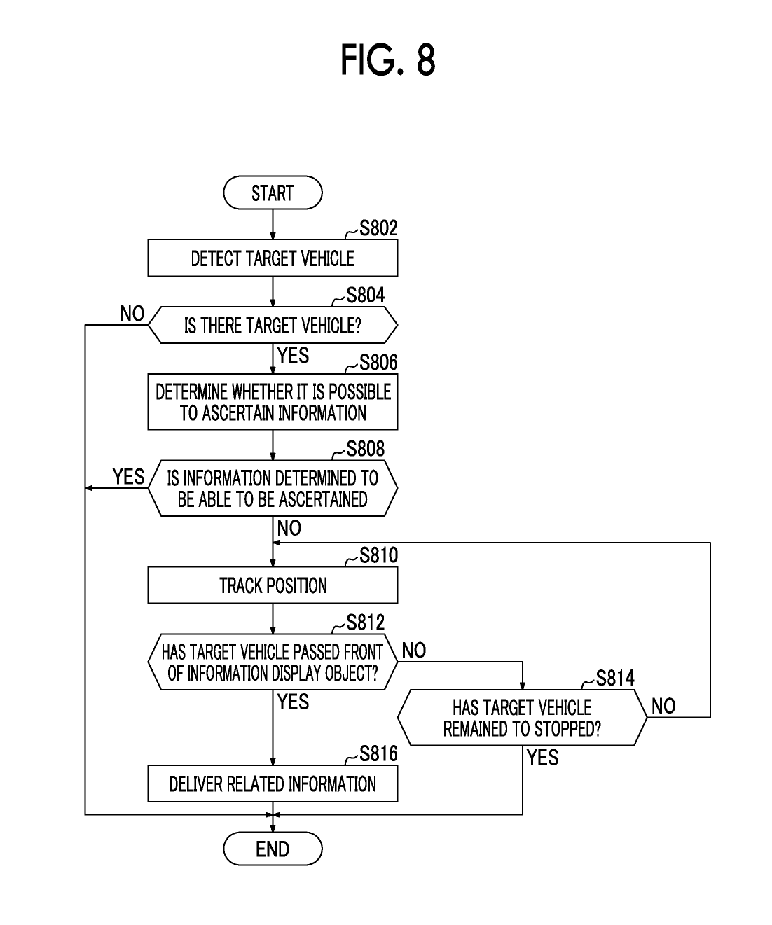

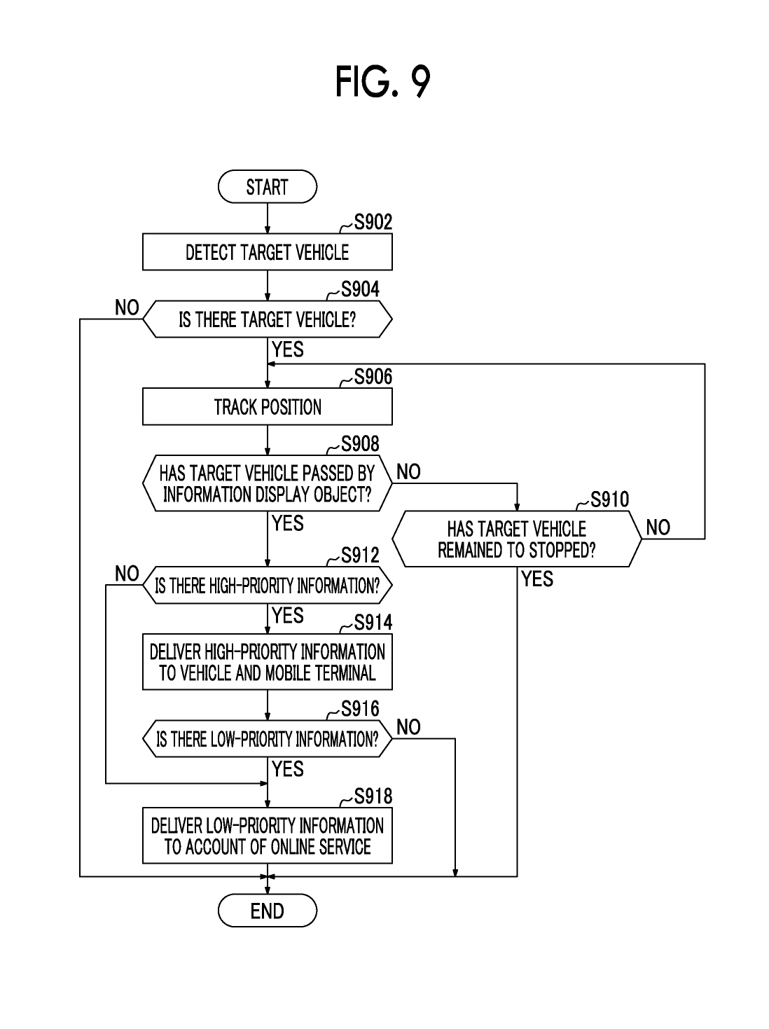

The processing routine described in the flowchart is performed on information display objects which are registered in the information display object DB 520F at predetermined intervals of time during operation of the central server 5. The same is true of the flowcharts illustrated in FIGS. 8 and 9 which will be described later.

In Step S502, the target vehicle detecting unit 5209 detects a vehicle 3 which is located near a target information display object.

In Step S504, the target vehicle detecting unit 5209 determines whether there is a vehicle 3 located near the information display object. The target vehicle detecting unit 5209 performs Step S506 when there is a vehicle 3 located near the information display object, and ends this processing routine otherwise.

The processes of Steps S506 to S512 are performed for each vehicle 3 detected through the process of Step S502.

In Step S506, the target vehicle detecting unit 5209 tracks the position of the vehicle 3 based on position information included in latest probe information of the detected vehicle 3 which is received by the communication processing unit 5201.

In Step S508, the target vehicle detecting unit 5209 determines whether the vehicle 3 has passed near the information display object. The target vehicle detecting unit 5209 performs Step S510 when the vehicle 3 has not passed near the information display object, and performs Step S512 when the vehicle 3 has passed near the information display object.

In Step S510, the target vehicle detecting unit 5209 determines whether the vehicle 3 remains stopped based on vehicle speed information included in the probe information of the vehicle 3 which is received by the communication processing unit 5201.

The state in which the vehicle 3 remains stopped represents a state in which the vehicle 3 stops for a relatively long time unlike stopping due to a traffic signal or the like. The target vehicle detecting unit 5209 returns to Step S506 and performs Steps S506 and S508 again when the vehicle 3 does not remain stopped, and ends this processing routine when the vehicle 3 remains stopped.

In Step S512, the information delivering unit 5211 delivers information related to the information display object to the vehicle 3 and the mobile terminal 4 of the user in the vehicle 3 which is ascertained by the boarding ascertaining unit 5210 via the communication processing unit 5201 as described above. The information delivering unit 5211 delivers the information related to the information display object to an account in a predetermined online service which is registered by a user in the vehicle 3 or a user who is likely to be in the vehicle 3 based on the user information DB 5201 as described above. Then, the processor 52 ends this processing routine.

FIGS. 6A, 6B, and 6C are diagrams illustrating a specific example of an operation of the central server 5 (the processor 52) when a vehicle 3 passes near specific information display objects (signboards SI1 and SI2). Specifically, FIG. 6A is a diagram illustrating a state in which a vehicle 3 traveling on a road link LK1 has passed by the fronts of the signboards SI1 and SI2 displaying advertisement information with nearby stores ST1 and ST2 as an advertisement object which are installed near a road side of the road link LK1. FIG. 6B is a diagram illustrating a specific example of related information which is displayed on the display device 37 of a vehicle 3 when the vehicle 3 has passed by the fronts of the signboards SI1 and SI2 in the road link LK1. FIG. 6C is a diagram illustrating another specific example of related information which is displayed on the display device 37 of a vehicle 3 when the vehicle 3 has passed by the fronts of the signboards SI1 and SI2.

As illustrated in FIG. 6A, the signboards SI1 and SI2 are disposed adjacent to the road side of the road link LK1.

The signboard SI1 displays advertisement information with a store of “FURNITURE INTERIOR STORE 00” (hereinafter referred to as a furniture store) ST1 on the road side of the road link LK2 on a right-turn side of the road link LK2 connected to a crossing CS1 when viewed from the road link LK1 as an advertisement object.

The signboard SI2 displays advertisement information with a store of “OOO OF TOYS” (hereinafter referred to as a toys store) ST2 on the road side of the road link LK3 on a left-turn side of the road link LK2 connected to the crossing CS1 when viewed from the road link LK1 as an advertisement object.

When a vehicle 3 passes by the fronts of the signboards SI1 and SI2, the processor 52 (the information delivering unit 5211) delivers related information of the signboards SI1 and SI2, that is, related information of the furniture store ST1 and the toys store ST2, to the vehicle 3 or the like as described above.

For example, as illustrated in FIG. 6B, additional information received from advertisers of the furniture store ST1 and the toys store ST2 by the additional information input receiving unit 5208 is delivered to the vehicle 3. Additional information 371 of the furniture store ST1 and additional information 372 of the toys store ST2 are displayed on the display device 37 of the vehicle 3 in a pop-up manner. Specifically, sale information is displayed in the additional information 371 of the furniture store ST1, and recommended goods of this month are displayed in the additional information 372 of the toys store ST2. The same additional information may be delivered to a user in the vehicle 3 or a user who is likely to be in the vehicle. Accordingly, a user in the vehicle 3 can be provided with additional information on the information displayed in the signboards SI1 and SI2 at the time of passing by the signboards SI1 and SI2. Accordingly, a user can easily understand information displayed in the signboards SI1 and SI2 even when the user has missed the signboards SI1 and SI2 or has seen the signboards SI1 and SI2 but cannot satisfactorily understand contents thereof. Particularly, in this example, since additional information which cannot be known from only the advertisement information with a focus on the names of the furniture store ST1 and the toys store ST2 can be provided to a user, it is possible to easily guide the users to the furniture store ST1 and the toys store ST2 and to improve advertising effects thereof.

For example, as illustrated in FIG. 6C, position information of the furniture store ST1 and the toys store ST2, specifically, route guidance information from the current position of the vehicle 3 to the furniture store ST1 and the toys store ST2, is delivered to the vehicle 3. The pieces of route guidance information 373 and 374 to the furniture store ST1 and the toys store ST2 are displayed on the display device 37 of the vehicle 3. Specifically, the route guidance information 373 includes route guidance information indicating that the furniture store ST1 is located on the left side immediately after turn right at the next crossing CS1 in the traveling direction of the vehicle 3 and additional information indicating that a large parking lot is prepared. The route guidance information 374 includes route guidance information indicating that the toys store ST2 is located on the left side in xxx meters after turn left at the next crossing CS1 in the traveling direction of the vehicle 3. The same route guidance information may be delivered to a user in the vehicle 3 or a user who is likely to be in the vehicle 3. Accordingly, the user in the vehicle 3 can be provided with information on the positions of the furniture store ST1 and the toys store ST2 which is guidance destination information displayed in the signboards SI1 and SI2, specifically, the route guidance information, at the time of passing by the signboards SI1 and SI2. Accordingly, the user can easily understand information displayed in the signboards SI1 and SI2 even when the user has missed the signboards SI1 and SI2 or has seen the signboards SI1 and SI2 but cannot satisfactorily understand the contents thereof. Particularly, in this example, since the position information (the route guidance information) of the furniture store ST1 and the toys store ST2 can be provided to a user, it is possible to improve convenience to the user, to easily guide the user to the furniture store ST1 and the toys store ST2, and to improve advertising effects thereof.

The processor 52 (the information delivering unit 5211) may deliver only one of the pieces of information related to the signboards SI1 and SI2, for example, the related information of one signboard which belongs to a taste genre suitable for taste characteristic of the user in the vehicle 3, to the vehicle 3 and the like.

[Operation]

As described above, in this embodiment, when a vehicle 3 detected near a predetermined information display object installed beside a road, just above the road, or the like passes near the information display object, the information delivering unit 5211 provides information related to the information display object to a user in the vehicle 3 or a user who is likely to be in the vehicle 3. For example, by delivering the related information to the vehicle 3 or delivering the related information to a mobile terminal 4 of a previously registered user of the vehicle 3, that is, a user who is likely to be in the vehicle 3, it is possible to provide the related information to the user via the display device 37 of the vehicle 3 or the display 45 of the mobile terminal 4.

Accordingly, even when an occupant in a vehicle 3 has missed an information display object or cannot satisfactorily understand information displayed on the information display object, information related to the information display object is provided and thus it is possible to facilitate the occupant understanding the information displayed on the information display object.

In this embodiment, the information delivering unit 5211 provides related information to a user by delivering the related information to a vehicle 3 or a mobile terminal 4 of the user.

Accordingly, the occupant can review the related information delivered to the vehicle 3 or the mobile terminal 4 in real time at the same time as the vehicle 3 passes by the front of the information display object. Accordingly, for example, in a case of an advertisement for guidance to a nearby store, it is possible to easily guide an occupant of the vehicle 3 to a guidance destination and to improve the effects of a guidance advertisement and the like.

In this embodiment, the information delivering unit 5211 may provide related information to a user by delivering the related information to an account corresponding to the user in an online service in which the user is able to receive and read information.

Accordingly, an occupant of a vehicle 3 can review the related information delivered to the occupant's account in a mail service or an SNS service which is used by the occupant later in a situation in which there is time to spare. Accordingly, for example, when an information display object is a web guidance advertisement, a user is in a vehicle 3, and there is no time to spare due to moving to a destination, the user can access the web in a situation in which there is time to spare and thus it is possible to improve the effects of the information display object (an advertisement).

In this embodiment, delivered related information includes information on a position of a guidance destination to which it is intended to guide a user by information displayed on the information display object.

Accordingly, for example, when an information display object is a guidance advertisement for guidance to a store or the like, position information of the guidance destination is provided to a user and thus it is possible to facilitate guidance of an interested user to a guidance destination and to improve the effects of a guidance advertisement or the like.

In this embodiment, delivered related information includes route guidance information to a guidance destination as information on a position of the guidance destination.

Accordingly, since route guidance information to a guidance destination is provided to a user, it is possible to improve convenience to a user who wants to go the guidance destination, to further facilitate guidance of a user to the guidance destination, and to further improve the effects of a guidance advertisement or the like.

In this embodiment, delivered related information includes supplementary information or detailed information of information displayed on an information display object.

Accordingly, in order to facilitate an occupant of a vehicle 3, a moving speed of which is relatively high and in which a time for noticing an information display object is restricted, understanding information, an amount of information displayed on the information display object may be limited. In this embodiment, supplementary information or detailed information of the information displayed on the information display object can be provided to an occupant. Accordingly, it is possible to further facilitate an occupant understanding the information displayed on the information display object.

In this embodiment, delivered related information includes newer information than information displayed on an information display object, that is, latest information.

Accordingly, even with an information display object such as a normal signboard of which frequent update of information is difficult, it is possible to provide latest information associated with the information displayed on the information display object, for example, sale information of a store which is a guidance destination of the guidance advertisement, to an occupant of a vehicle 3.

In this embodiment, related information is stored in the related information DB 520G of the storage unit 520 in correlation with an information display object registered in the information display object DB 520F. The additional information input receiving unit receives input related information and stores the received new related information in the related information DB 520G in correlation with the information display object, and the information delivering unit 5211 provides the related information stored in the related information DB 520G to a user.

Accordingly, since the related information stored in correlation with the information display object can be additionally input, for example, by a manager of the central server 5 or an advertiser of the advertisement information displayed on the information display object, it is possible to enrich the related information and to improve the effects of the information display object (an advertisement).

In this embodiment, the related information collecting unit 5207 collects related information of information display objects based on online information (crawl information) including web information or SNS information. Web information is, for example, information which is provided over the Internet. SNS information is, for example, information written by SNS users. The related information collecting unit 5207 stores the collected related information in the related information DB 520G in correlation with corresponding information display objects.

Accordingly, since information related to information display objects is collected based on online information and is stored as related information in correlation with the information display objects, it is possible to enrich the related information and to improve the effects of the information display objects (advertisements).

In this embodiment, the information display object extracting unit 5205 of the central server 5 extracts an information display object from a captured image received from a probe vehicle (a vehicle 3) including the camera 36 that images surroundings by the communication processing unit 5201. The information display object extracting unit 5205 stores the extracted information display object and position information of the information display object in the information display object DB 520F in correlation with each other. Here, the position information of the information displayed object may be acquired by the position information of the probe vehicle.

Accordingly, since an information display object is extracted from a captured image of the camera 36 of a probe vehicle (a vehicle 3) and is stored in correlation with position information thereof, it is possible to increase the number of information display objects of which related information is delivered. Accordingly, it is possible to improve convenience to an occupant of a vehicle 3.

In this embodiment, the information display object searching unit 5206 searches for an information display object and position information thereof based on online information (crawl information) including web information or SNS information, and stores a newly searched information display object and position information of the information display object in the information display object DB 520F in correlation with each other.

Accordingly, since an information display object and position information thereof are searched for based on online information and the searched information display object and the position information thereof are stored in correlation with each other, it is possible to increase the number of information display objects of which related information is delivered. Accordingly, it is possible to improve convenience to an occupant of a vehicle 3.

### Second Embodiment

A second embodiment will be described below.

An information delivery system 1 according to this embodiment is different from the information delivery system 1 according to the first embodiment, in that an information understanding determining unit 5212 is added as a functional unit of the processor 52 of the central server 5. The information delivery system 1 according to this embodiment is different from the information delivery system 1 according to the first embodiment, in that conditions for delivering related information in the information delivering unit 5211 are modified. In the following description, the same elements as in the first embodiment will be referred to by the same reference signs and differences therebetween will be mainly described.

[Configuration of Information Delivery System]

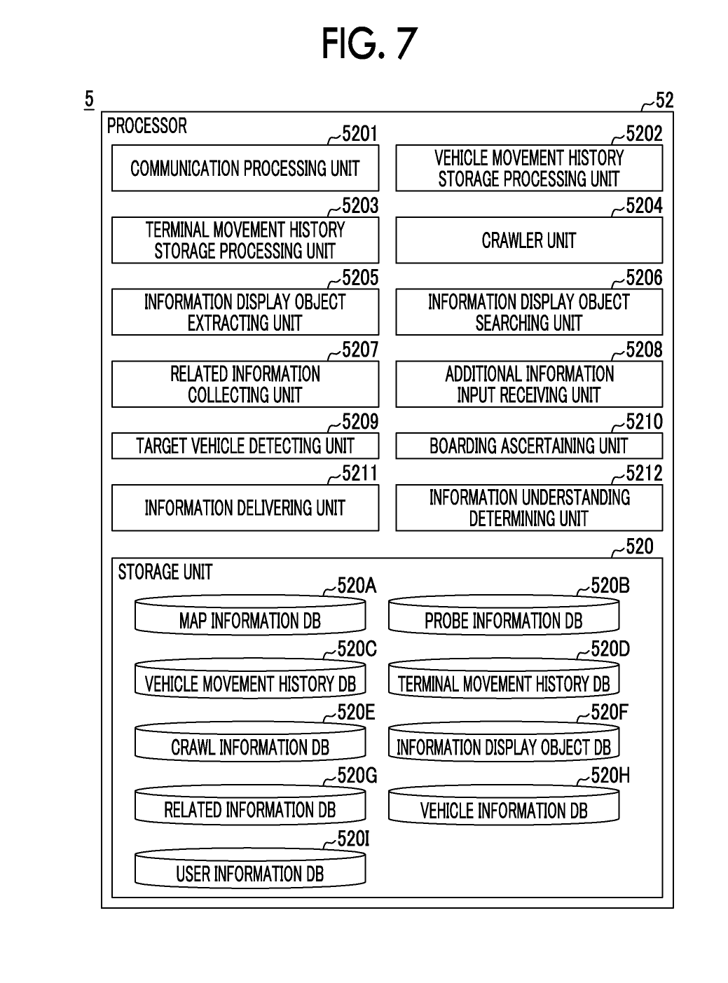

The configuration of the information delivery system 1 according to this embodiment will be described below with reference to FIG. 7.

FIG. 7 is a functional block diagram illustrating an example of the functional configuration of the central server 5 (the processor 52) according to this embodiment.

The configuration of the information delivery system 1 as a whole, the functional configuration of a vehicle 3 (an ECU 32), and the functional configuration of a mobile terminal 4 (a processor 42) are the same as illustrated in FIGS. 1 to 3 and thus description thereof will not be repeated.

The processor 52 includes a communication processing unit 5201, a vehicle movement history storage processing unit 5202, a terminal movement history storage processing unit 5203, a crawler unit 5204, an information display object extracting unit 5205, an information display object searching unit 5206, a related information collecting unit 5207, an additional information input receiving unit 5208, a target vehicle detecting unit 5209, a boarding ascertaining unit 5210, an information delivering unit 5211, and an information understanding determining unit 5212 as functional units which are embodied, for example, by causing the CPU to execute one or more programs stored in the ROM or the auxiliary storage device of a server computer. The processor 52 also includes a storage unit 520 as a storage area which is defined in the auxiliary storage device or an external storage device connected to the server computer. A map information DB 520A, a probe information DB 520B, a vehicle movement history DB 520C, a terminal movement history DB 520D, a crawl information DB 520E, an information display object DB 520F, a related information DB 520G, a vehicle information DB 520H, and a user information DB 520I are stored in the storage unit 520.

The information understanding determining unit 5212 (an example of a determination unit) determines whether there is a likelihood that an occupant of a target vehicle (a vehicle 3) detected by the target vehicle detecting unit 5209 cannot understand information displayed on an information display object.

For example, the information understanding determining unit 5212 determines whether there is a likelihood that an occupant of a vehicle 3 cannot understand information displayed on an information display object based on vehicle speed information included in latest probe information received from the vehicle 3 by the communication processing unit 5201. Specifically, the information understanding determining unit 5212 may determine that there is a likelihood that an occupant of a vehicle 3 cannot understand information displayed on an information display object when the vehicle speed of the vehicle 3 is equal to or higher than a predetermined speed. The predetermined speed which is a threshold value may be appropriately defined based on experiment, existing research results about human kinetic eyesight, or the like.

For example, the information understanding determining unit 5212 determines whether there is a likelihood that an occupant of a vehicle 3 cannot understand information displayed on an information display object based on whether the information display object is in a backlight state when the information display object is viewed by the occupant of the vehicle 3. Specifically, the information understanding determining unit 5212 may determine whether the information display object is in a backlight state based on position information of the vehicle 3 included in the latest probe information received from the vehicle 3 by the communication processing unit 5201, weather information at the position of the vehicle 3, and an azimuth and angle of the sun at the current time at the current position of the vehicle 3. The information understanding determining unit 5212 can acquire weather information at the position of the vehicle 3 or information on the azimuth and angle of the sun, for example, from an external weather information server. When the information display object is in a backlight state when the information display object is viewed by an occupant of the vehicle 3, the information understanding determining unit 5212 may determine that there is a likelihood that an occupant of the vehicle 3 cannot understand information displayed on the information display object.

For example, the information understanding determining unit 5212 determines whether there is a likelihood that an occupant of the vehicle 3 cannot understand information displayed on the information display object based on whether the surroundings of the information display object have bad weather. Bad weather can include a fog, a heavy rain (a rain in which an amount of rainfall per unit time is equal to or greater than a predetermined amount), a heavy snow (a snow in which an amount of snowfall per unit time is equal to or greater than a predetermined amount), a hail, a soft hail, or the like. Specifically, the information understanding determining unit 5212 may determine whether surroundings of the information display object have bad weather based on weather information at the installation position of the information display object which is acquired, for example, from an external weather information server. When the surroundings of the information display object have bad weather, the information understanding determining unit 5212 may determine that there is a likelihood that an occupant of the vehicle 3 cannot understand information displayed on the information display object.

When it is determined that the vehicle 3 which is a target vehicle detected by the target vehicle detecting unit 5209 has passed near the corresponding information display object and the information understanding determining unit 5212 determines that there is a likelihood that an occupant of the vehicle 3 cannot understand information displayed on the information display object, the information delivering unit 5211 delivers information related to the information display object to the vehicle 3 and a mobile terminal 4 of the user in the vehicle 3 which is identified by the boarding ascertaining unit 5210.

When it is determined that the target vehicle (the vehicle 3) detected by the target vehicle detecting unit 5209 has passed near the corresponding information display object and the information understanding determining unit 5212 determines that there is a likelihood that an occupant of the vehicle 3 cannot understand information displayed on the information display object, the information delivering unit 5211 delivers information related to the information display object to an account corresponding to a user in the vehicle 3 or a user who is likely to be in the vehicle 3 in an online service in which the user is registered.

Accordingly, it is possible to achieve the same advantages as in the first embodiment, and since the related information is provided to the user in the vehicle 3 only when it is determined that there is a likelihood that an occupant of the vehicle 3 cannot understand information displayed on the information display object, it is possible to prohibit the related information from being provided to a user who does not want provision of the related information.

[Details of Operation of Information Delivery System]A specific operation of the information delivery system 1 according to this embodiment will be described below with reference to FIG. 8.

FIG. 8 is a flowchart schematically illustrating an example of a processing routine which is performed by the processor 52 of the central server 5 according to this embodiment.

Since Steps S802, S804, and S810 to S816 are the same as Steps S502, S504, and S506 to S512 in the first embodiment (FIG. 5), description thereof will not be repeated and differences therefrom will be mainly described.

The processes of Steps S806 to S816 are performed on each vehicle 3 detected through the process of Step S802.

When it is determined in Step S804 that there is a vehicle 3 located near the information display object, the information understanding determining unit 5212 determines whether there is a likelihood that an occupant of the vehicle 3 detected by the target vehicle detecting unit 5209 cannot understand information displayed on the information display object in Step 5806.

The information understanding determining unit 5212 performs Step 5810 when it is determined in Step 5808 that there is a likelihood that an occupant of the vehicle 3 cannot understand information displayed on the information display object, and ends this processing routine otherwise.

[Operation]

As described above, in this embodiment, the information understanding determining unit 5212 determines whether there is a likelihood that an occupant of the vehicle 3 detected by the target vehicle detecting unit 5209 cannot understand information displayed on the information display object. When it is determined that the vehicle 3 detected by the target vehicle detecting unit 5209 has passed near the corresponding information display object and the information understanding determining unit 5212 determines that there is a likelihood that an occupant of the vehicle 3 cannot understand information displayed on the information display object, the information delivering unit 5211 delivers information related to the information display object to a user in the vehicle 3 or a user who is likely to be in the vehicle 3.

Accordingly, since the related information is provided to the user in the vehicle 3 or the like only when it is determined that there is a likelihood that an occupant of the vehicle 3 cannot understand information displayed on the information display object, it is possible to prohibit the related information from being provided to a user who does not want provision of the related information. Accordingly, it is possible to curb inconvenience which is given to a user who does not want the related information.

In this embodiment, the information understanding determining unit 5212 determines that there is a likelihood that a user cannot understand information displayed on the information display object when the vehicle speed of the vehicle 3 is equal to or higher than a predetermined speed, when the information display object is in a backlight state when the information display object is seen by an occupant of the vehicle 3, or when the surroundings of the information display object have predetermined bad weather.

Accordingly, it is possible to specifically determine whether there is a likelihood that an occupant of the vehicle 3 cannot understand information displayed on the information display object based on the vehicle speed of the vehicle 3, the positional relationship between the vehicle 3 and the information display object, and the weather near the information display object.

### Third Embodiment

A third embodiment will be described below.

An information delivery system 1 according to this embodiment is different from the information delivery system 1 according to the first embodiment, in that a delivery destination of related information is changed depending on a priority level which is defined in advance for the related information. In the following description, the same elements as in the first embodiment will be referred to by the same reference signs and differences therebetween will be mainly described.

The configuration of the information delivery system 1 is the same as in the first embodiment illustrated in FIGS. 1 to 4.

[Configuration of Information Delivery System]

Similarly to the first embodiment, the information delivering unit 5211 delivers information related to an information display object to a vehicle 3, a mobile terminal 4 of a user in the vehicle 3 or a user who is likely to be in the vehicle, and an account corresponding to the user in an online service in which the user registers information when the target vehicle detecting unit 5209 determines that the target vehicle (the vehicle 3) has passed near the corresponding information display object. At this time, the information delivering unit 5211 changes a delivery destination of the related information depending on a priority level which is defined in advance for the related information stored in the related information DB 520G in correlation with the information display object.

Specifically, the information delivering unit 5211 delivers related information with a relatively high priority level (that is, the priority level is equal to or higher than a predetermined reference) among the related information of the target information display object stored in the related information DB 520G to the vehicle 3 and the mobile terminal 4 of the user in the vehicle 3 or the user who is likely to be in the vehicle. On the other hand, the information delivering unit 5211 delivers related information with a relatively low priority level (that is, the priority level is lower than the predetermined reference) among the related information of the target information display object stored in the related information DB 520G to an account corresponding to the user in the online service. Accordingly, it is possible to facilitate an occupant of the vehicle 3 understanding the related information with a relatively high priority level in real time by transmission to the vehicle 3 or the mobile terminal 4 and to facilitate the occupant understanding the related information with a relatively low priority level through an online service later. Accordingly, when there are a plurality of pieces of related information of one information display object and the plurality of pieces of related information are provided to the same providing means at one time, an amount of information is excessively large and thus there is a likelihood that understanding of the information related to the information display object will not be facilitated. However, by properly using the providing means depending on the priority level, it is possible to facilitate understanding of the related information.

A priority level is defined in advance for each piece of related information stored in the related information DB 520G using an arbitrary method.

For example, types of contents of information displayed on an information display object, position information including route guidance information of a place, an establishment, or the like associated with the information displayed on the information display object, detailed information of the information displayed on the information display object, supplementary information of the information displayed on the information display object, and word-of-mouth information associated with the information displayed on the information display object such as latest information of the information displayed on the information display object can be defined in the related information. Accordingly, for example, in the related information, a relatively high priority level may be defined for such a type of related information requiring real time properties, and a relatively low priority level may be defined for such a type of related information not requiring real time properties. For example, such a type of related information requiring real time properties can include contents of the information displayed on the information display object. This is because the contents thereof need to be provided to a user of the vehicle 3 having missed the information display object. Such type of related information requiring real time properties can include position information including route guidance information of a place, an establishment, or the like associated with the information displayed on the information display object. This is because a user can be guided to a place, an establishment, or the like associated with the information displayed on the information display object in real time.

As described above, a registration time of the related information is correlated with the related information stored in the related information DB 520G. Accordingly, among related information of a certain information display object, a relatively high priority level may be defined for the related information of which the registration time is relatively later (specifically, registered after a predetermined time), and a relatively low priority level may be defined for the related information of which the registration time is relatively early (specifically, registered before a predetermined time). Accordingly, it is possible to preferentially provide related information of which the registration time is relatively late, that is, so-called related information with higher freshness, to a user in the vehicle 3 in real time.

Priority information input by a manager, an advertiser, or the like may be added to additional information which is received by the additional information input receiving unit 5208, and the priority information may be reflected when the received additional information is stored as related information in the related information DB 520G Accordingly, it is possible to reflect intent of a manager of the central server 5, an advertiser, or the like in the priority level of the related information.

[Details of Operation of Information Delivery System]

A specific operation of the information delivery system 1 according to this embodiment will be described below with reference to FIG. 9.

FIG. 9 is a flowchart illustrating schematically illustrating an example of a processing routine which is performed by the processor 52 of the central server 5 according to this embodiment. Hereinafter, among related information of a target information display object, related information with a relatively high priority level is referred to as high-priority information, and related information with a relatively low priority level is referred to as low-priority information.

Since Steps S902 to S910 are the same as Steps S502 to S510 in the first embodiment (FIG. 5), description thereof will not be repeated and differences therefrom will be mainly described. The processes of Steps S906 to S918 are performed on each vehicle 3 detected through the process of Step S902.

When it is determined in Step S908 that the vehicle 3 detected by the target vehicle detecting unit 5209 has passed near an information display object, the information delivering unit 5211 determines whether there is high-priority information in the related information of the information display object stored in the related information DB 520G in Step S912. The information delivering unit 5211 performs Step S914 when there is high-priority information, and performs Step S916 when there is no high-priority information.

In Step S914, the information delivering unit 5211 delivers the high-priority information of the related information of the information display object to the vehicle 3 and a mobile terminal 4 of a user in the vehicle 3 specified by the boarding ascertaining unit 5210 via the communication processing unit 5201.

In Step S916, the information delivering unit 5211 determines whether there is low-priority information in the related information of the information display object stored in the related information DB 520G The information delivering unit 5211 performs Step S918 when there is low-priority information, and ends this processing routine when there is no low-priority information.

In Step S918, the information delivering unit 5211 delivers the related information of the information display object to an account in a predetermined online service in which a user in the vehicle 3 or a user who is likely to be in the vehicle is registered based on the user information DB 5201 via the communication processing unit 5201, and then ends this processing routine.

[Operation]

As described above, in this embodiment, the information delivering unit 5211 delivers related information with a relatively high priority level to a vehicle 3 and a mobile terminal 4 of a user in the vehicle 3 or a user who is likely to be in the vehicle. On the other hand, the information delivering unit 5211 may provide the related information to a user by delivering related information with a relatively low priority level to an account corresponding to the user in the online service.

Accordingly, it is possible to facilitate an occupant of a vehicle 3 understanding related information with a relatively high priority level in real time by transmission to the vehicle 3 or the mobile terminal 4 and to facilitate the occupant understanding related information with a relatively low priority level later via an online service. Accordingly, when there are a plurality of pieces of related information of one information display object and the plurality of pieces of related information are provided to the same providing means at one time, an amount of information is excessively large and thus there is a likelihood that understanding of the related information of the information display object will not be facilitated. However, by properly using the providing means depending on the priority level, it is possible to facilitate understanding of the related information. For example, by defining a relatively high priority level for related information requiring real time properties (for example, route guidance information to a nearby store) and defining a relatively low priority level for related information of which later understanding is allowed (for example, URL information of a web page), it is possible to provide information depending on characteristics of the providing means.

While embodiments of the disclosure have been described above in detail, the disclosure is not limited to such specific embodiments and can be modified in various forms within the range of gist of the disclosure described in the appended claims.

For example, in the above-mentioned embodiment, some functions of the central server 5 may be assigned to another server which can communicate with the central server 5.

In the above-mentioned embodiments, related information is delivered to all of a vehicle 3, a mobile terminal 4 of a user in the vehicle 3 or a user who is likely to be in the vehicle, and an account of an online service in which the user is registered, but may be delivered to some thereof.

In the above-mentioned embodiments, when a vehicle 3 has passed near an information display object, related information of the information display object is provided to a user, but related information of an object other than the information display object, for example, related information of a landmark such as an establishment or a famous place, may be provided to a user.

In the above-mentioned embodiments, when a vehicle 3 has passed near an object (an information display object) in the real world, related information of the object (the information display object) is displayed, but related information of a virtual object in an augmented reality (AR) environment may be provided to the user. For example, when information on a place as the AR environment is overlaid on the display 45 on which an image captured by a camera mounted in a mobile terminal 4 is displayed in a predetermined AR application which is installed in the mobile terminal 4 and a vehicle 3 passes through a position in the real world corresponding to an object in the AR environment, related information of the object in the AR environment may be provided to a user in the vehicle 3 or the like.

What is claimed is:

1. An information providing device comprising:
a target vehicle detecting unit configured to detect a vehicle which is located near an information display object displaying information; and
an information providing unit configured to provide related information which is related to the information displayed on the information display object to at least one of a user in the vehicle and a user who is likely to be in the vehicle when the vehicle detected by the target vehicle detecting unit has passed near the information display object.

2. The information providing device according to claim 1, further comprising
a determination unit configured to determine whether there is a likelihood that an occupant of the vehicle detected by the target vehicle detecting unit is not able to understand the information displayed on the information display object, wherein
the information providing unit is configured to provide the related information to the user when the vehicle detected by the target vehicle detecting unit has passed near the information display object and when the determination unit has determined that there is the likelihood.

3. The information providing device according to claim 2, wherein
the determination unit is configured to determine that there is the likelihood when at least one of Condition (i), Condition (ii), and Condition (iii) is satisfied:
(i) a vehicle speed of the vehicle is equal to or higher than a predetermined speed;
(ii) the information display object is in a backlight state when the occupant looks toward the information display object and
(iii) surroundings of the information display object have predetermined bad weather.

4. The information providing device according to claim 1, wherein
the information providing unit is configured to provide the related information to the user by delivering the related information to the vehicle or a mobile phone of the user.

5. The information providing device according to claim 1, wherein
the information providing unit is configured to provide the related information to the user by delivering the related information to an account corresponding to the user in an online service through which the user is able to receive and read information.

6. The information providing device according to claim 1, wherein
a priority is defined for the related information in advance, and
a priority of related information which the information providing unit delivers to the vehicle or a mobile terminal of the user is higher than a priority of related information which the information providing unit delivers to an account corresponding to the user in an online service, and the user being able to receive and read information through the online service.

7. The information providing device according to claim 1, wherein
the related information includes position information of a position of a guidance destination to which the user is guided by the information displayed on the information display object.

8. The information providing device according to claim 7, wherein
the related information includes route guidance information to guide the user to the guidance destination.

9. The information providing device according to claim 1, wherein
the related information includes supplementary information or detailed information on the information displayed on the information display object.

10. The information providing device according to claim 1, wherein
the related information includes latest information related to the information displayed on the information display object at a time when the information providing unit provides the related information.

11. The information providing device according to claim 1, further comprising a related information storing unit configured to store the related information in correlation with the information display object.

12. The information providing device according to claim 11, further comprising an input receiving unit configured to receive the related information which is input, wherein
the related information storing unit is configured to store the related information received by the input receiving unit in correlation with the information display object.

13. The information providing device according to claim 11, further comprising an information collecting unit configured to collect the related information based on online information including at least one of web information and SNS information, wherein
the related information storing unit is configured to store the related information collected by the information collecting unit in correlation with the information display obj ect.

14. The information providing device according to claim 1, further comprising an information display object storing unit configured to store a data corresponding to the information display object and position information of the information display object in correlation with the data.

15. The information providing device according to claim 14, further comprising:
an image receiving unit configured to receive a captured image which is captured by an imaging unit that images the surroundings of a vehicle from the vehicle including the imaging unit; and
an extraction unit configured to extract an image of the information display object as the data from the captured image.

16. The information providing device according to claim 14, further comprising a search unit configured to search for the data and the position information based on online information including web information or SNS information.

17. An information providing method which is performed by an information providing device, the information providing method comprising:
causing the information providing device to detect a vehicle which is located near an information display object displaying information; and
causing the information providing device to provide related information which is related to the information displayed on the information display object to at least one of a user in the vehicle and a user who is likely to be in the vehicle when the vehicle detected in the detecting of a vehicle has passed near the information display object.

18. A computer-readable non-transitory recording medium on which a program is recorded, the program including:
an operation of detecting a vehicle which is located near an information display object displaying information; and
an operation of providing related information which is related to the information displayed on the information display object to at least one of a user in the vehicle and a user who is likely to be in the vehicle when the vehicle detected in the detecting of a vehicle has passed near the information display object.
